(19) United States
(12) Patent Application Publication
(10) Pub. No.: US 2012/0217314 A1
(43) Pub. Date: Aug. 30, 2012

(54) EAS PIN COMBINED WITH A PLASTIC ENCAPSULATED RFID TAG TO BE CONNECTED TO AN EAS LABEL, PARTICULARLY FOR TRACKING ARTICLES OF CLOTHING

(76) Inventors: Zoltán Váthy, Zalaszentgrot (HU); Zoltán Péter Perecz, Zalaszentgrot (HU)

(21) Appl. No.: 13/508,100

(22) PCT Filed: Nov. 5, 2010
(86) PCT No.: PCT/HU2010/000120

§ 371 Date: May 4, 2012

(30) Foreign Application Priority Data
Nov. 5, 2009 (HU) P0900694

(51) Int. Cl. G06K 19/077

(52) U.S. Cl. 235/492

(57) ABSTRACT

An anti theft tag with separated encapsulated RFID tag and an EAS label, wherein the tag comprises a first plastic body equipped with an EAS label, a second plastic body in which a pin engagable to an EAS label is accommodated, said pin is releasably lockable to a locking mechanism of the EAS label, the pin has a head and a stem formed so that it may be engaged with the locking mechanism of the EAS label, and further, the second plastic body contains an RFID inlay. Said plastic body can be injection moulded onto said RFID tag. The operating frequency band of the RFID tag is adjusted by the material of the plastic body and the thickness of the material encapsulating said RFID tag. The material of the plastic body preferably comprises a filling material having a relative dielectric constant exceeding that of the base material. The RFID tag can be inserted into a cavity of said plastic body composed of two parts defining said cavity.

This is the national stage of International Application PCT/HU2010/000120, filed Nov. 5, 2010.

The object of the invention is an anti theft tag with separated encapsulated RFID tag and an EAS label, wherein the tag comprises a first plastic body equipped with an EAS label, a second plastic body in which a pin engagable to an EAS label is accommodated, said pin is releasably lockable to a locking mechanism of the EAS label, the pin has a head and a stem formed so that it may be engaged with the locking mechanism of the EAS label, and further, the second plastic body contains an RFID inlay.

It has been recognised that plastic encapsulated electronic article protecting labels (using the abbreviation for the generally known Electronic Article Surveillance, hereinafter referred to as EAS label) can be favourably combined with RFID technology. The significance of the use of such combination has been recognised but in every case the aim was the integration of the two technologies see the examples in US patents U.S. Pat. No. 7,183,917, U.S. Pat. No. 7,109,867 B2, and U.S. Pat. No. 5,939,984, and the publications US 2009/0189768 A1 and US 2008/0048863 A1. The pin or pin assembly that can be releasably engaged to the locking mechanism of the EAS label was left unchanged; such pin or pin assembly commonly contains a pin comprising a pinhead and a stem, as well as a cap, metal or plastic body that enhances visibility, manageability and palpability.

The solutions produced according to the referred publications always result in the size increase of the product or in case of their introduction, require the complete replacement of the EAS label stocks in use. In order to achieve a high quality product, it may need to be tested for both aspects in the course of production, which deteriorates both the cycle time and the output of production.

A further disadvantage is that such integrated products have to be produced specifically for various EAS label designs (radio-frequency, acousto-magnetic, magnetic, microwave systems, etc.)

The locking mechanism of EAS labels are described in U.S. Pat. No. 7,190,272 B2 and U.S. Pat. No. 5,528,914, in the following, these are referred to as a locking mechanism. From document WO 2004/104958 an identification tag is known that includes a combination of RFID elements and EAS elements, or multiple RFID elements without an EAS element, or multiple EAS elements without RFID elements. The elements are included in the same housing. In US 2001/035822 which is considered as the closest prior art document there is disclosed an anti theft tack device incorporating a detectable element which can be attached to the body component of an existing electronic article surveillance security tag to replace the tack-like connecting component of the security tag. The anti theft tack device includes a connecting element, a base element, a housing that encloses elements whose proximity is detectable by the in-store electronic equipment, a means to releaseably secure the device to the article to be protected, and a means to releaseably engage the device to the body component of an existing surveillance tag. Engagement of the present device to a surveillance tag provides the ability to upgrade an existing surveillance tag incorporating a first detection technology to a second type of detection technology.

When developing the invention, the objective was to provide an anti theft tag with a pin assembly that can be attached to any system of EAS labels and wherein the pin assembly is combined with a plastic encapsulated RFID tag which eliminates the above disadvantages at the same time. In the course of the realisation of the above object it has been found that these two functions, i.e. EAS and RFID can be realised not only within a single body but as two product parts or two plastic bodies that can be engaged with one another.

The objective of the invention is the elimination of known deficiencies and to develop an anti theft tag comprising a first plastic body in which an EAS label is accommodated and a second plastic body with a pin to be attached to the locking mechanism of the EAS label formed in accordance with any of the above patents and wherein the second body contains a plastic encapsulated RFID tag. Thus, the anti theft tag—after its attachment—has the advantages of the RFID tag and the EAS systems. Alternatively, when the second body with the RFID inlay itself is attached to a generally known EAS locking mechanism—not including the electronic article surveillance function or EAS label—offers the advantages of RFID tags as identifiers and thereby it is capable of fulfilling an independent function similar to EAS systems.

The objectives of the invention have been obtained by the development of the anti theft tag according to Claim 1. The preferable embodiments of the anti theft tag according to the invention are specified in the dependent claims.

Thus, the solution according to the invention is an anti theft tag with separated encapsulated RFID tag and EAS label, wherein the tag comprises a first plastic body equipped with an EAS label, a second plastic body in which a pin to be engaged to an EAS label is accommodated, and further, the second plastic body contains an RFID inlay. The essence of the invention is that the electronic article surveillance (EAS) system and the RFID system is not embedded in a single product part or plastic body but are attached to an article as separate means. The device so engaged performs the identifying function of the RFID tag, the article protection of EAS and the function of being attached to the object to be identified. The second body (with the pin assembly and the RFID inlay) of the combined anti theft tag according to the invention can be produced in two steps: by plastic injection moulding, ultrasonic welding, adhesive bonding or by any other technology used in the plastic industry. The RFID tag contained therein is of a generally used technology that comprises an antenna and an identifying chip.

The second body according to the invention can be attached to a first body comprising an EAS label using any widespread technology, therefore the security gates used for their detection need not be replaced regardless of whether they use acousto-magnetic or RF systems. Alternatively, in many cases the RFID tag according to the invention can be used in itself. In addition to the advantages provided by the RFID tag technology, it is in itself capable of fulfilling the intelligent article surveillance function within the limitations of the RFID tag technology. Thereby a product of smaller size can be produced, which is an advantage in the trade of clothing articles and it has also smaller costs.

The solution according to the invention appears to be more costly then the former solutions at a first sight. However, taking into account that the integration of common EAS labels with RFID tags gives rise to numerous technical problems, and a few, otherwise unnecessary measures have to be taken in order to make the integration possible, the actual costs arising from the invention do not increase but rather decrease. Additionally, considering the fact that EAS labels and RFID tags can perform different functions independently of one another, and that an RFID tag is capable to fulfil separately other types of functions, it can be seen that the concept according to the invention represents a cost-effective solution. It is also more cost-effective when some kind of an EAS system is already in use because only the second body or pin assembly of the anti theft tag according to the invention has to be purchased and the already existing EAS labels and gates can be kept on being used, only RFID tag reading devices have to be installed at the desired locations.

Further features and advantages of the anti theft tag of the present invention wherein a pin assembly combined with a plastic encapsulated RFID tag is to be attached to an EAS label become apparent from the following description of the preferred embodiments with reference to the attached drawings, wherein:

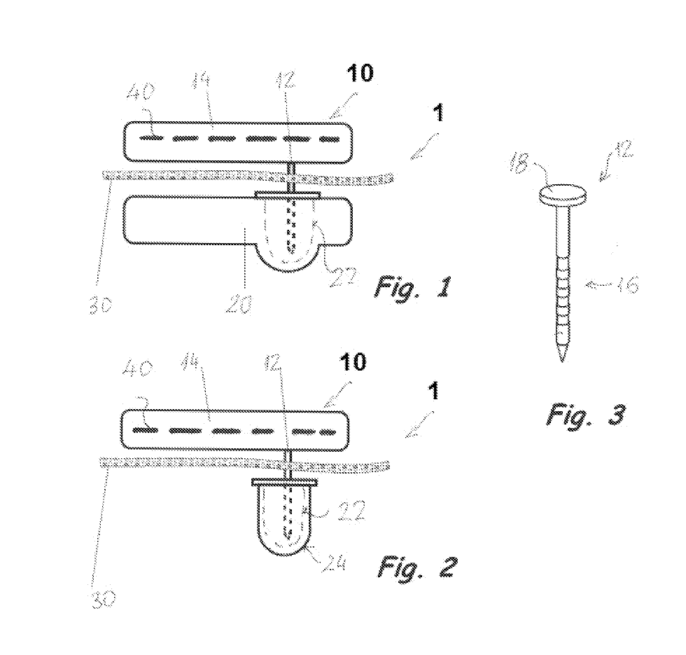

FIG. 1 is the schematic side view of the combined pin assembly and RFID inlay according to the invention, wherein the pin is pierced through a piece of fabric and is engaged to an EAS label.

FIG. 2 is the schematic side view of the combined pin assembly and RFID inlay according to the invention, wherein the pin is pierced through a piece of fabric and connected to a locking mechanism without EAS label.

FIG. 3 is a perspective view of the pin applied for the solution according to the invention in itself.

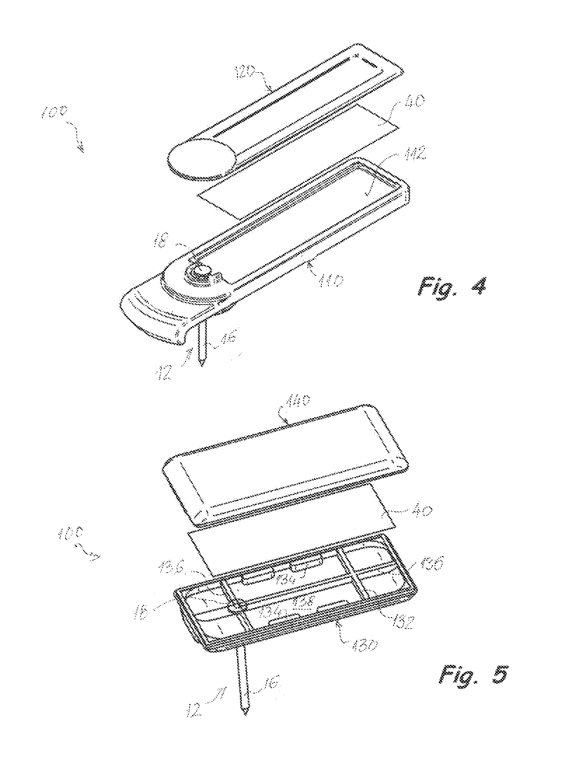

FIG. 4 is the exploded perspective view of the combined pin assembly and RFID inlay provided in a second plastic body made by injection moulding.

FIG. 5 is the exploded perspective view of the combined pin assembly and RFID inlay provided in a second plastic body made of two pieces attached to one another.

FIG. 1 shows the anti theft tag 1 of the invention with a first body 20 made of plastic in which an EAS label (not shown) is accommodated and a second body 14 made of plastic. The second body 14 is provided with a pin 12 and thereby said second body 14 and said pin 12 form a pin assembly 10,100. Further, the second body 14 comprises a plastic encapsulated RFID tag or inlay 40. The pin 12 of the pin assembly 10 is pierced through the piece of fabric 30 representing the article to be identified and protected (e.g. articles of clothing, leather goods, other accessories, etc.). Further, the pin 12 of the pin assembly 10 is connected to the locking mechanism 22 of the first body 20 accomodating the EAS label.

FIG. 2 is different from FIG. 1 in that the pin 12 of the pin assembly 10 is engaged in a locking mechanism 22 provided with a casing 24 without an EAS label.

FIG. 3 shows the pin 12 of the pin assembly 10 according to the invention, which pin 12 has a head 18 and a stem 16 formed to be releasably locked to the locking mechanism 22. From the pin assembly 10, only the stem 16 of the pin is 12 protruding, its head 18 is accommodated in the second body 14, and thereby it is firmly fixed to the second body 14. The second body 14 accommodates an RFID inlay 40 symbolically illustrated by a dashed line on FIGS. 1 and 2. The pin 12 is generally known and used for attaching EAS labels to articles to be protected.

In case of the embodiment of FIG. 4, the second body 14 of the anti theft tag 1 is made by injection moulding in two steps. Its lower part 110 produced in a first step accommodates the head 18 of the pin 12, and the stem 16 of the pin 12 protrudes downwards from the lower part 110 as shown at the Figure. The pin 12 can also be inserted into the injection moulding device before the injection moulding, and in this case the lower part 110 tightly accommodates the pin 12. According to another solution, an opening (not shown in the Figure) remains on the lower part 110 after the injection moulding wherein the stem 16 of the pin 12 can be inserted, and its head 18 hits against the lower part 110. In the lower part 110, an indentation 112 is formed, wherein the RFID inlay 40 fits into. The indentation 112 defines the position of the RFID inlay 40. The RFID inlay 40 is fixed against displacement by adhesive bonding, for which the adhesive may be applied either on the bottom of the indentation 112 or on the lower surface of the RFID inlay 40. The adhesive layer is expediently a pressure sensitive adhesive applied to the lower surface of the RFID inlay 40 during manufacturing. The lower part 110, together with the pin 12 therein and with the RFID inlay 40 can be placed into another injection moulding die, and the upper part 120 of the EAS pin assembly 100 is formed in such a position by way of a second injection moulding.

In case of the embodiment of FIG. 4, the plastic body constituted by the lower part 110 and the upper part 120 is in direct contact with the RFID inlay 40, therefore it significantly influences the operating frequency range of the RFID inlay 40. Such influence is mainly defined by the dielectric constant and wall thickness of the material of the lower part 110 and the upper part 120.

In case of the embodiment according to FIG. 5, the plastic body is constituted by a lower part 130 and an upper part 140, which are manufactured separately. The lower part 130 accommodates the pin 12, which in this case can be inserted in the injection moulding device before the injection moulding, but is may also be inserted into a (not shown) opening formed in the lower part 130 for this purpose. In this case, indentations 138 are formed both on the lower part 130 and the upper part 140, which indentations 138 define a closed cavity as a capsule after the lower part 130 and the upper part 140 have been appropriately fixed together. In case of the upper part 140 the indentation is not shown, but it may be formed in corresponding the indentation 138 of the lower part 130. The wall thickness of the capsule is defined by the distance between the bottom of the indentation 138 and the respective lower and upper surfaces of the lower part 130 and upper part 140.

In the indentation 138, there are distance pieces, namely 132, 136 ribs and 134 supports, which are locally touching the RFID inlay 40, and which are located at proper spacings for maintaining the position of the RFID inlay 40 placed on a flexible plastic sheet, for maintaining its distance from the lower part 130 and the upper part 140. Where there is no such touching, there is an air-gap between the RFID inlay 40 and the lower part 130 and upper part 140 constituting the plastic body. The position of the RFID inlay 40 can be stabilised by auxiliary adhesive bonding, which facilitates the assembly and bonding of the lower part 130 with the upper part 140. They may be assembled manually, by auxiliary adhesive bonding, ultrasonic welding, adhesive bonding or by any other method used in the plastic industry; and the exact layout of the lower part 130 and the upper part 140 is defined by the selected manufacturing technology. The RFID inlay 40 can be obtained in the form of a label or can be formed in the course of the manufacture of the product. In both cases, it comprises an antenna and a chip.

The anti theft tag of the invention with a plastic RFID tag encapsulated in a second body and attachable to a first plastic body accommodating an EAS label provides the following advantages over the generally used, disposable labels integrated (e.g. sewn) into the label in the article of clothing:

By its multiple use, significant cost reduction can be achieved.

It can be applied in retail trade units in a first step, then in central warehouses, therefore its testing and implementation in practice is easier, and results in saving costs sooner. This is contrary to disposable items, which are typically placed on the articles by the manufacturers, and manufacturers can be very far from the place of trading; or the owner of a brand can have articles manufactured by several independent manufacturers, and therefore the introduction or modification of the application of disposable labels is quite difficult, and what is more, the suppliers interests are not necessarily the same as those of the client or the dealer, not to mention that problems that may arise due to the difference in the communication technologies.

The RFID tag according to the invention do not have to be deactivated after sale as other RFID tags (e.g. ones sewn into the clothing or adhered to the clothing label) do have to, as they are not to be taken out of the store but will be reused several times.

In relation to the above, the advantages of the use of the RFID tag according to the invention in the trade of clothing and accessories can be summarised as follows:
Faster, more accurate and cost-effective stock management and sales.
Faster, more accurate and cost-effective inventory taking.
Stock accounting is more accurate, the occurrence of stock shortages is less likely, therefore less sales can be lost.
It makes the application of intelligent article surveillance solutions possible (sensors for the RFID tags can be placed in the changing rooms, the process of association with articles and their removal can be linked to persons, prompt and accurate information is available on articles tried to be stolen).
Improved shopping experience (by sensors located in the appropriate places, supplementary offers can be made for the article of clothing recognised based on the RFID tag, e.g. on appropriate displays.)
It makes the collection of various types of data possible (e.g. clothes tried on but not purchased, frequency of trying on), and thereby the different processes, the sales can be traced better, the planning of operation and the management of sales can be controlled.

The RFID inlay used for the solution according to the invention can be e.g. an adhesive UPM Raflatac (Pirkkala, Finland) make, code 3001400 device, which can operate in the frequency range between 902-928 MHz. This is a standard used in the USA and defined by FCC. By injection moulding, this RFID tag device can be tuned to the 865.6-867.6 MHz frequency used in Europe and defined by ETSI, particularly, with a plastic having a lower dielectric constant and/or with a smaller wall thickness, a reliably operating product can be produced that operates properly in the original 902-928 MHz frequency range, especially in its lower range, which can be handled be RFID tag reading devices.

The steps of designing the product:
determining the desired frequency range of the product to be manufactured according to the invention
selecting or manufacturing an RFID inlay having a frequency higher than desired frequency
selecting the materials which have the appropriate dielectric constant and mechanical strength and which can be injection moulded well
determining the wall thicknesses that provide the appropriate mechanical strength.

Selection of the most appropriate variation of the above three (e.g. iteration, test planning. The order of the above three steps is not fixed, they may be performed in any order, therefore fine tuning is possible afterwards (e.g. after the test article is manufactured).

An example for a product realised in accordance with the above.
Target range: as per ETSI
RFID inlay applied: UPM Raflatac 3001723. Its reading distance at an EAS frequency differing from the target frequency range did not reach 1 meter before its tuning with the plastic. Depending on the actual needs and possibilities, RFID inlays of other manufacturers may also be used. Such other manufacturers are: Alien Technology (Morgan Hill Calif. 95037 US), Avery Dennison (Flowery Branch, Ga. 30542, US)
Plastic: 70% Polypropylene, mixed with 30% glass fibre by the manufacturer
Wall thicknesses: Lower part 2.5 mm, upper part 1.5 mm

It is worth noting that in case of a higher performance RFID tag, a version tuned to the entire UHF range can be used (e.g. UPM Raflatac Short Dipole); in this case the effect of the plastic is not so significant that it would prevent its use both on ETSI and FCC frequencies.

The process of manufacturing:
Moulding the first component
Insertion of the pin
Producing an interim-phase product by adhesive bonding of the RFID inlay
Placing the interim-phase product back to the injection moulding device
Moulding on the second component

Another version of the manufacturing process:
Insertion of the pin into the injection moulding device
Moulding the first component
Adhesive bonding of the RFID inlay
Putting the whole back to the injection moulding device
Moulding on the second component,

Process of the embodiment using air-gap:
determining the desired frequency range of the product to be manufactured according to the invention
selecting or manufacturing an RFID inlay operating at a frequency within the desired frequency range (this can be and preferably is the entire UHF (860-960 MHz) range)
selecting the materials which have the appropriate dielectric constant and mechanical strength and which can be injection moulded well
determining the wall thicknesses that provide the appropriate strength.
determining the appropriate air-gap
determining the most appropriate variation of the above three (e.g. iteration, test planning)

An example:
Target range: entire UHF range
RFID inlay: UPM Raflatac 3001636 or 3001723
Plastic: ABS
Characteristic wall thickness: 0.9 mm
Air-gap (both below and above the inlay) 2.3 mm 2.3 mm

The manufacturing process:
Injection moulding of the lower and upper components either together with the pin or with a pin inserted afterwards
fixing the RFID inlay to one of the components (e.g. adhesive bonding at the edges, bearing)
Ultrasonic welding or adhesive bonding of the lower and upper components to one another

In case the RFID inlay is not placed in the RFID tag between the two steps of the injection moulding but it is placed in a chamber, where it is separated from the encapsulating case by an air-gap, another type of RFID tag device can also be used, such as the 3001723 or 3001636 code UPM Raflatac devices, which can operate in the frequency range between 860-960 MHz. The referred RFID inlays are obviously provided as examples, any other RFID inlay meeting the actual needs and requirements can be used instead. In this respect, it has to be noted that the permitted frequency range may vary by country. In case of the use of a plastic having the appropriate dielectric constant, the use of a filling material for increasing the dielectric constant may be omitted.

The efficient range achievable with the RFID tag according to the invention was approximately 4 meters at ETSI frequency (with the above 3001723, it was max 1 meter previously). In case injection moulding, several thermoplastic materials, such as polypropylene, polycarbonate, ABS, etc. may be used for the production of the plastic body. The plastic changes the operating frequency range depending on the dielectric constant of the material used and the wall thickness of the plastic surrounding the RFID inlay. The relative dielectric constant of polypropylene (PP) is between the range of 2.2. and 2.6, while the relative dielectric constant of polycarbonate varies in a wider range, between 2.9 and 4, and the relative dielectric constant of ABS is approximately 2.7 to 3.1. Considering that the operating frequency range realised is primarily influenced by the dielectric constant, it may be adjusted by adding glass fibre having a higher dielectric constant. The relative dielectric constant of such glass fibre is e.g. 3.8, and taking a mix of 70 weight % PP and 30 weight % glass fibre as a basis, we determine the frequency range to be realised after injection moulding. In case of a certain geometry, the desired frequency range can be adjusted by changing the mixing ratio as necessary. For example, for the frequency range defined by FCC, a mix of 80 weight % PP and 20 weight % glass fibre can be taken as a basis. Of course, the wall thickness can be modified as well, however, in such case the injection moulding device has to be modified, therefore it is more expedient to change the mixing ratio.

In case the RFID inlay is placed into the cavity formed in the plastic body afterwards, the effect of the plastic imposed on the operating frequency is a lot smaller, especially if the stabilisation of the air-gap between the RFID tag and the wall of the cavity is ensured. In such case, the effect of the wall thickness of the plastic imposed on the frequency shift is much smaller.

A person skilled in the art (e.g. on the basis of experience obtained in connection with the planning and measurement carried out respecting three RFID tags) can achieve the desired result in three to five steps after having defined the exterior geometry of the RFID tag, meaning that such person can tune the frequency range of the RFID inlay to the desired range.

1-6. (canceled)

7. Anti theft tag (1) comprising:
a first plastic body (20) accommodating an EAS label,
a second body (14) provided with a pin (12), said second body (14) and said pin (12) together form a pin assembly (10,100), the pin (12) is adapted to be releasably locked to a locking mechanism (22) of the first plastic body (20), characterized in that
the second body (14) accommodates an RFID inlay (40).

8. Anti theft tag (1) according to claim 7, characterised in that the second body (14) is injection moulded onto the RFID inlay (40).

9. Anti theft tag (1) according to claim 8, characterised in that operating frequency range of the RFID inlay (40) is determined by the material of the second body (14) and its thickness surrounding the RFID inlay (40).

10. Anti theft tag (1) according to claim 9, characterised in that the material of the second body (14) contains a filling material, the dielectric constant of which is greater than that of the second plastic body (14).

11. Anti theft tag (1) according to claim 10, characterised in that the material of the second body (14) is selected from polypropylene, polycarbonate, ABS, or similar plastic materials or the mixture of these materials, and that the filling material is glass fibre.

12. Anti theft tag (1) according to claim 8 with a pin assembly (100), characterised in that the second plastic body (14) is assembled from two parts (120, 130), and that such two parts (120, 130) define a closed cavity, and the RFID inlay (40) is accommodated by the cavity (138), and that in the cavity (138) there are distance pieces which are formed to define the position of the RFID inlay (40) and which locally touch the outer surface of the RFID inlay (40) at places, and there is an air-gap between the remaining parts of the surface of the RFID inlay (40) and the inner surface of the cavity (138.)
